(19) United States
(12) Patent Application Publication
(10) Pub. No.: US 2018/0305842 A1
(43) Pub. Date: Oct. 25, 2018

(54) POLYURETHANE FIBER INCLUDING COPOLYMER POLYOL

(71) Applicant: INVISTA NORTH AMERICA S.A R.L., Wilmington, DE (US)

(72) Inventors: Hong LIU, Waynesboro, VA (US); Achille M BIVIGOU KOUMBA, Greensboro, NC (US); Norman J. D'ALLURA, Waynesboro, VA (US); Tianyi LIAO, Chadds Ford, PA (US); Andreas J. BLAB, Kennett Square, PA (US); Ronald D. BING-WO, Waynesboro, VA (US)

(73) Assignee: INVISTA NORTH AMERICA S.A R.L., WILMINGTON, DE (US)

(21) Appl. No.: 15/737,995

(22) PCT Filed: Jun. 26, 2016
(86) PCT No.: PCT/US2016/040026

§ 371 Date: Dec. 19, 2017

Related U.S. Application Data
(60) Provisional application No. 62/187,048, filed on Jun. 30, 2015.

(51) Int. Cl. D01F 6/70; C08G 61/12; C08L 75/08; D02G 3/32

(52) U.S. Cl. CPC D01F 6/70; C08G 61/124; C08K 5/17; D02G 3/32; C08L 2203/12; C08L 75/08

(57) ABSTRACT

Fibers including a polyurethaneurea that is the reaction product of (a) a prepolymer including the reaction product of (i) a polyol including a copolymer of tetrahydrofuran and 3-methyltetrahydrofuran having a number average molecular weight of 1000 to 2000 and (ii) a diisocyanate; and (b) a chain extender, and fabrics and hygiene articles including such fibers.

### BACKGROUND OF THE INVENTION

### Field of the Invention

Included are elastic fibers prepared from a prepolymer including the reaction product of a (i) a polyol including a copolymer of tetrahydrofuran and 3-methyltetrahydrofuran having a number average molecular weight of 1000 to 2000; (ii) a diisocyanate; and (c) a chain extender.

### Description of the Related Art

Polyurethaneurea solution spun spandex fiber derived from copolymer polyols are known. For example, U.S. Patent Application Publication No. 2006/0135724 A1 to Lawrey et al. discloses a spandex fiber derived from a polyol blend that may include a PTMEG copolymer and including a diamine chain extender blend. This fiber provides fabrics that have a favorable heat-set efficiency.

### SUMMARY OF THE INVENTION

By contrast to the related art, the fibers of the present invention are durable in that they maintain their retractive power after heat treatment. In addition the fibers have a higher retractive power compared to commercially available spandex of the same denier. These fibers include a polyurethaneurea that is the reaction product of (a) a prepolymer including the reaction product of (i) a polyol including a copolymer of tetrahydrofuran and 3-methyltetrahydrofuran having a number average molecular weight of 1000 to 2000 and (ii) a diisocyanate; and (b) a chain extender. The copolymer of tetrahydrofuran and 3-methyltetrahydrofuran may have any suitable number average molecular weight (MW) such as 1200 to 1800. Other suitable MW may be 1300 to 1500.

In an aspect of the invention, the prepolymer has % NCO of 2.6 to 3.6, preferably from 2.8 to 3.2.

In another aspect of the invention, the chain extender is a diamine chain extender, such as a linear diamine chain extender. In yet a further aspect of the invention, the chain extender consists only of ethylene diamine.

In a further aspect of the invention, the polyol includes only the copolymer of tetrahydrofuran and 3-methyltetrahydrofuran or a combination of the copolymer and a different polyol. The different polyol may include a single additional polyol or a blend of polyols selected from the group consisting of polycarbonate glycols, polyester glycols, polyether glycols and combinations thereof.

In an additional aspect of the invention, the polyol includes about 50% to about 100% of the copolymer of tetrahydrofuran and 3-methyltetrahydrofuran. In yet another aspect of the invention, the copolymer of tetrahydrofuran and 3-methyltetrahydrofuran includes about 5 to about 75 mole % of 3-methyltetrahydrofuran, such as 5-25 mole % or 10-20 mole %.

Another aspect of the invention is a fabric including an elastic fiber including a polyurethaneurea that is the reaction product of: (a) a prepolymer including the reaction product of: (i) a polyol including a copolymer of tetrahydrofuran and 3-methyltetrahydrofuran having a number average molecular weight of 1000 to 2000 and (ii) a diisocyanate; and (b) a chain extender.

In an embodiment of the invention, the fabric retains power after heat treatment.

In an additional embodiment of the invention, the fabric comprises a knit or woven construction.

A further aspect of the invention is a hygiene article including a polyurethaneurea that is the reaction product of: (a) a prepolymer including the reaction product of: (i) a polyol including a copolymer of tetrahydrofuran and 3-methyltetrahydrofuran having a number average molecular weight of 1000 to 2000 and (ii) a diisocyanate; and (b) a chain extender.

### DETAILED DESCRIPTION OF THE INVENTION

### Definitions

As used herein, “solvent” refers to an organic solvent such as dimethylacetamide (DMAC), dimethylformamide (DMF) and N-methyl pyrrolidone.

The term “solution-spinning” as used herein includes the preparation of a fiber from a solution which can be either a wet-spun or dry-spun process, both of which are common techniques for fiber production.

In order to help insure suitability of the spandex fiber to yarn processing, fabric manufacturing, and consumer satisfaction when contained in a garment, a number of additional properties can be adjusted. Spandex compositions are well-known in the art and may include may variations such as those disclosed in Monroe Couper. Handbook of Fiber Science and Technology: Volume III, High Technology Fibers Part A. Marcel Dekker, INC: 1985, pages 51-85. Some examples of those are listed here.

Spandex fiber may contain a delusterant such as TiO₂, or another other particle with at refractive index different from the base fiber polymer, at levels of 0.01-6% by weight. A lower level is also useful when a bright or lustrous look is desired. As the level is increased the surface friction of the yarn may change which can impact friction at surfaces the fiber contacts during processing.

The fiber breaking strength as measured in grams of force to break per unit denier (tenacity in grams/denier) may be adjusted from 0.7 to 1.2 grams/denier dependent on molecular weight and/or spinning conditions.

The denier of the fiber may be produced from 5-2000 or above based on the desired fabric construction. A spandex yarn of denier 5-30 denier may have a filament count of between 1 and 5, and a yarn of denier 30-2000 may have a filament count from 20 to 200. The fiber may be used in fabrics of any sort (wovens, warp knits, or weft knits) in a content from 0.5% to 100%/a depending on the desired end use of the fabric.

The spandex yarn may be used alone or it may be plied, twisted, co-inserted, or mingled with any other yarn such as those suitable for apparel end uses, as recognized by the FTC (Federal Trade Commission). This includes, but is not limited to, fibers made from nylon, polyester, multi-component polyester or nylon, cotton, wool, jute, sisal, help, flax, bamboo, polypropylene, polyethylene, polyfluorocarbons, rayon, cellulosics of any kind, and acrylic fibers.

The spandex fiber may have a lubricant or finish applied to it during the manufacturing process to improve downstream processing of the fiber. The finish may be applied in a quantity of 0.5 to 10% by weight. Alternatively, the fiber may be produced without a lubricant or finish.

The spandex fiber may contain additives to adjust the initial color of the spandex or to prevent or mask the effects of yellowing after exposure to elements that can initiate polymer degradation such as chlorine, fumes, UV, NOx, or burnt gas. A spandex fiber may be made to have a “CIE” whiteness in the range of 40 to 160.

### Polyurethaneurea and Polyurethane Compositions

Polyurethaneurea compositions useful for preparing fiber or long chain synthetic polymers that include at least 85% by weight of a segmented polyurethane. Typically, these include a polymeric glycol or polyol which is reacted with a diisocyanate to form an NCO-terminated prepolymer (a “capped glycol”), which is then dissolved in a suitable solvent, such as dimethylacetamide, dimethylformamide, or N-methylpyrrolidone, and then reacted with a difunctional chain extender. Polyurethanes are formed when the chain extenders are diols (and may be prepared without solvent). Polyurethaneureas, a sub-class of polyurethanes, are formed when the chain extenders are diamines. In the preparation of a polyurethaneurea polymer which can be spun into spandex, the glycols are extended by sequential reaction of the hydroxy end groups with diisocyanates and one or more diamines. In each case, the glycols must undergo chain extension to provide a polymer with the necessary properties, including viscosity. If desired, dibutyltin dilaurate, stannous octoate, mineral acids, tertiary amines such as triethylamine, N,N′-dimethylpiperazine, and the like, and other known catalysts can be used to assist in the capping step.

Suitable polyol components include polyether glycols, polycarbonate glycols, and polyester glycols of number average molecular weight of about 600 to about 3,500. Mixtures of two or more polyols or copolymers can be included.

Examples of polyether polyols that can be used include those glycols with two or more hydroxy groups, from ring-opening polymerization and/or copolymerization of ethylene oxide, propylene oxide, trimethylene oxide, tetrahydrofuran, and 3-methyltetrahydrofuran, or from condensation polymerization of a polyhydric alcohol, such as a diol or diol mixtures, with less than 12 carbon atoms in each molecule, such as ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polyether polyol is preferred, and a poly(tetramethylene ether) glycol of molecular weight of about 1,700 to about 2,100, such as Terathane® 1800 (INVISTA of Wichita, Kans.) with a functionality of 2, is one example of a specific suitable polyol. Co-polymers can include poly(tetramethylene-co-ethyleneether) glycol.

Examples of polyester polyols that can be used include those ester glycols with two or more hydroxy groups, produced by condensation polymerization of aliphatic polycarboxylic acids and polyols, or their mixtures, of low molecular weights with no more than 12 carbon atoms in each molecule. Examples of suitable polycarboxylic acids are malonic acid, succinic acid, glutaric acid, adipic acid, pimelic acid, suberic acid, azelaic acid, sebacic acid, undecanedicarboxylic acid, and dodecanedicarboxylic acid. Examples of suitable polyols for preparing the polyester polyols are ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear bifunctional polyester polyol with a melting temperature of about 5° C. to about 50° C. is an example of a specific polyester polyol.

Examples of polycarbonate polyols that can be used include those carbonate glycols with two or more hydroxy groups, produced by condensation polymerization of phosgene, chloroformic acid ester, dialkyl carbonate or diallyl carbonate and aliphatic polyols, or their mixtures, of low molecular weights with no more than 12 carbon atoms in each molecule. Examples of suitable polyols for preparing the polycarbonate polyols are diethylene glycol, 1,3-propanediol, 1,4-butanediol, 1,5-pentanediol, 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polycarbonate polyol with a melting temperature of about 5° C. to about 50° C. is an example of a specific polycarbonate polyol.

The prepolymer formed when the polymeric glycol or polyol is reacted with the diisocyanate may suitably have a percentage of NCO (“% NCO”) of the prepolymer of 2.6 to 3.6, preferably from 2.8 to 3.2.

The diisocyanate component can also include a single diisocyanate or a mixture of different diisocyanate including an isomer mixture of diphenylmethane diisocyanate (MDI) containing 4,4′-methylene bis(phenyl isocyanate) and 2,4′-methylene bis(phenyl isocyanate). Any suitable aromatic or aliphatic diisocyanate can be included. Examples of diisocyanates that can be used include, but are not limited to, 1-isocyanato-4-[(4-isocyanatophenyl)methyl]benzene, 1-isocyanato-2-[(4-cyanatophenyl)methyl]benzene, bis(4-isocyanatocyclohexyl)methane, 5-isocyanato-1-(isocyanatomethyl)-1,3,3-trimethylcyclohexane, 1,3-diisocyanato-4-methyl-benzene, 2,2′-toluenediisocyanate, 2,4′-toluenediisocyanate, and mixtures thereof. Examples of specific polyisocyanate components include Mondur® ML (Bayer), Lupranate® MI (BASF), and Isonate® 50 O,P′ (Dow Chemical), and combinations thereof.

A chain extender may be either water or a diamine chain extender for a polyurethaneurea. Combinations of different chain extenders may be included depending on the desired properties of the polyurethaneurea and the resulting fiber. Examples of suitable diamine chain extenders include: hydrazine; 1,2-ethylenediamine; 1,4-butanediamine; 1,2-butanediamine; 1,3-butanediamine; 1,3-diamino-2,2-dimethylbutane; 1,6-hexamethylenediamine; 1,12-dodecanediamine; 1,2-propanediamine; 1,3-propanediamine; 2-methyl-1,5-pentanediamine; 1-amino-3,3,5-trimethyl-5-aminomethylcyclohexane; 2,4-diamino-1-methylcyclohexane; N-methylamino-bis(3-propylamine); 1,2-cyclohexanediamine; 1,4-cyclohexanediamine; 4,4′-methylene-bis(cyclohexylamine); isophorone diamine; 2,2-dimethyl-1,3-propanediamine; meta-tetramethylxylenediamine; 1,3-diamino-4-methylcyclohexane; 1,3-cyclohexane-diamine; 1,1-methylene-bis(4,4′-diaminohexane); 3-aminomethyl-3,5,5-trimethylcyclohexane; 1,3-pentanediamine (1,3-diaminopentane); m-xylylene diamine; and Jeffamine® (Texaco).

When a polyurethane is desired, the chain extender is a diol. Examples of such diols that may be used include, but are not limited to, ethylene glycol, 1,3-propanediol, 1,2-propylene glycol, 3-methyl-1,5-pentanediol, 2,2-dimethyl-1,3-trimethylene diol, 2,2,4-trimethyl-1,5-pentanediol, 2-methyl-2-ethyl-1,3-propanediol, 1,4-bis(hydroxyethoxy)benzene, and 1,4-butanediol and mixtures thereof.

A blocking agent which is a monofunctional alcohol or a monofunctional dialkylamine may optionally be included to control the molecular weight of the polymer. Blends of one or more monofunctional alcohols with one or more dialkylamine may also be included.

Examples of monofunctional alcohols useful with the present invention include at least one member selected from the group consisting of aliphatic and cycloaliphatic primary and secondary alcohols with 1 to 18 carbons, phenol, substituted phenols, ethoxylated alkyl phenols and ethoxylated fatty alcohols with molecular weight less than about 750, including molecular weight less than 500, hydroxyamines, hydroxymethyl and hydroxyethyl substituted tertiary amines, hydroxymethyl and hydroxyethyl substituted heterocyclic compounds, and combinations thereof; including furfuryl alcohol, tetrahydrofurfuryl alcohol, N-(2-hydroxyethyl)succinimide, 4-(2-hydroxyethyl)morpholine, methanol, ethanol, butanol, neopentyl alcohol, hexanol, cyclohexanol, cyclohexanemethanol, benzyl alcohol, octanol, octadecanol, N,N-diethylhydroxylamine, 2-(diethylamino)ethanol, 2-dimethylaminoethanol, and 4-piperidineethanol, and combinations thereof.

Examples of suitable mono-functional dialkylamine blocking agents include: N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tert-butyl-N-isopropylamine, N-isopropyl-N-cyclohexylamine, N-ethyl-N-cyclohexylamine, N,N-diethanolamine, and 2,2,6,6-tetramethylpiperidine.

### Additives

Classes of additives that may be optionally included in polyurethaneurea compositions are listed below. An exemplary and non-limiting list is included. However, additional additives are well-known in the art. Examples include: anti-oxidants, UV stabilizers, colorants, pigments, cross-linking agents, phase change materials (paraffin wax), antimicrobials, minerals (i.e., copper), microencapsulated additives (i.e., aloe vera, vitamin E gel, aloe vera, sea kelp, nicotine, caffeine, scents or aromas), nanoparticles (i.e., silica or carbon), nano-clay, calcium carbonate, talc, flame retardants, antitack additives, chlorine degradation resistant additives, vitamins, medicines, fragrances, electrically conductive additives, dyeability and/or dye-assist agents (such as quaternary ammonium salts). Other additives which may be added to the polyurethaneurea compositions include adhesion promoters, anti-static agents, anti-creep agents, optical brighteners, coalescing agents, electroconductive additives, luminescent additives, lubricants, organic and inorganic fillers, preservatives, texturizing agents, thermochromic additives, insect repellants, and wetting agents, stabilizers (hindered phenols, zinc oxide, hindered amine), slip agents (silicone oil) and combinations thereof.

The additive may provide one or more beneficial properties including: dyeability, hydrophobicity (i.e., polytetrafluoroethylene (PTFE)), hydrophilicity (i.e., cellulose), friction control, chlorine resistance, degradation resistance (i.e., antioxidants), adhesiveness and/or fusibility (i.e., adhesives and adhesion promoters), flame retardance, antimicrobial behavior (silver, copper, ammonium salt), barrier, electrical conductivity (carbon black), tensile properties, color, luminescence, recyclability, biodegradability, fragrance, tack control (i.e., metal stearates), tactile properties, set-ability, thermal regulation (i.e., phase change materials), nutriceutical, delusterant such as titanium dioxide, stabilizers such as hydrotalcite, a mixture of huntite and hydromagnesite, UV screeners, and combinations thereof.

### Process of Making Fibers

The fiber of some embodiments is produced by solution spinning (either wet-spinning or dry spinning) of the polyurethane-urea polymer from a solution with conventional urethane polymer solvents (e.g., DMAc). The polyurethaneurea polymer solutions may include any of the compositions or additives described above. The polymer is prepared by reacting an organic diisocyanate with appropriate glycol, to produce a “capped glycol”. The capped glycol is then reacted with a mixture of diamine chain extenders. In the resultant polymer, the soft segments are the polyether/urethane parts of the polymer chain. These soft segments exhibit melting temperatures of lower than 60° C. The hard segments are the polyurethane/urea parts of the polymer chains; these have melting temperatures of higher than 200° C. The hard segments amount to 5.5 to 9%, preferably 6 to 7.5%, of the total weight of the polymer.

In one embodiment of preparing fibers, the polymer solutions containing 30-40% polymer solids are metered through desired arrangement of distribution plates and orifices to form filaments. Extruded filaments are dried by introduction of hot, inert gas at 300° C.-400° C. and a gas:polymer mass ratio of at least 10:1 and drawn at a speed of at least 400 meters per minute (preferably at least 600 m/min) and then wound up at a speed of at least 500 meters per minute (preferably at least 750 m/min). All examples given below were made with 80° C. extrusion temperature into a hot inert gas atmosphere at a wind-up speed of 762 m/min. Standard process conditions are well-known in the art.

Strength and elastic properties of the spandex were measured in accordance with the general method of ASTM D 2731-72. For the examples reported in Tables below, spandex filaments having a 5 cm gauge length were cycled between 0% and 300% elongation at a constant elongation rate of 50 cm per minute. Modulus was determined as the force at 100% (M100) and 200% (M200) elongation on the first cycle and is reported in grams. Unload modulus (U200) was determined at 200% elongation on the fifth cycle and is reported in the Tables in grams. Percent elongation at break and force at break was measured on the sixth extension cycle.

Percent set was determined as the elongation remaining between the fifth and sixth cycles as indicated by the point at which the fifth unload curve returned to substantially zero stress. Percent set was measured 30 seconds after the samples had been subjected to five 0-300% elongation/relaxation cycles. The percent set was then calculated as % Set=100(Lf−Lo)/Lo, where Lo and Lf are the filament (yam) length, when held straight without tension, before (Lo) and after (Lf) the five elongation/relaxation cycles.

The features and advantages of the present invention are more fully shown by the following examples which are provided for purposes of illustration, and are not to be construed as limiting the invention in any way.

### EXAMPLES

### Example 1 (Comparative)

Terathane® 1800 glycol of 100.00 parts by weight was mixed and reacted with Isonate® 125MDR MDI of 23.47 parts, with the capping ratio (NCO/OH) at 1.69, to form an isocyanate-terminated prepolymer with a percent of isocyanate groups (—NCO) at 2.60% of the prepolymer. This prepolymer was then dissolved in N,N-dimethylacetamide (DMAc) of 165.52 parts. This diluted prepolymer solution was allowed to react with a mixture of amines in DMAc solution, containing 1.94 parts of EDA, 0.42 parts of Dytek*A, 0.03 parts of DETA, 0.42 parts of DEA and 71.05 parts of DMAc using a high speed disperser to form a homogenous polyurethaneurea solution with a polymer solids about 34.8% and a viscosity of 2600 poises measured at 40° C. This polymer solution was mixed with a slurry of additives including 4.0% bleach resistant agent, 0.17% delusterant, 1.35% antioxidant, 0.5% dye-assist agent, 0.3% spinning aid and 0.4% anti-tack additive based on the solid weight.

### Example 1a

The polymer solution with mixed additives from Example 1 was spun into a 40 denier spandex yarn with 4 filaments twisted together at a wind-up speed of 869 meters per minute. The as-spun yarn properties of this test item were measured and listed in Table 1.

### Example 1b

The polymer solution with mixed additives from Example 1 was spun into a 70 denier spandex yarn with 5 filaments twisted together at a wind-up speed of 674 meters per minute. The as-spun yarn properties of this test item were measured and listed in Table 1.

### Example 2

PTG L-1400 glycol (copolymer of 3Me-THF and THF including 14 mole % 3Me-THF and number average molecular weight 1400) of 300.00 parts by weight was mixed and reacted with Isonate® 125MDR MDI of 87.16 parts, with the capping ratio (NCO/OH) at 1.658, to form an isocyanate-terminated prepolymer with a percent of isocyanate groups (—NCO) at 3.00% of the prepolymer. This prepolymer was then dissolved in N,N-dimethylacetamide (DMAc) of 571.06 parts. This diluted prepolymer solution was allowed to mix and react with 271.77 parts of a mixture of diamine extender in DMAc solution (containing 7.35 parts of EDA, 1.58 parts of Dytek®A, and 262.84 parts of DMAc) and 8.90 parts of DEA in DMAc solution (containing 0.78 parts of DEA and 8.12 parts of DMAc) to form a homogenous polyurethaneurea solution with a polymer solids about 32.0% and a viscosity of 5000 poises measured at 40° C. This polymer solution was mixed with a slurry of additives including 4.0% bleach resistant agent, 0.17% delusterant, 1.35% antioxidant, 0.5% dye-assist agent, 0.3% spinning aid and 0.4% anti-tack additive based on the solid weight.

### Example 2a

The mixed solution from Example 2 was spun into a 40 denier spandex yarn with 4 filaments twisted together at a wind-up speed of 869 meters per minute. The as-spun yarn properties of this test item were measured and listed in Table 1.

### Example 2b

The mixed solution from Example 2 was spun into a 40 denier spandex yarn with 4 filaments twisted together at a wind-up speed of 1042 meters per minute. The as-spun yarn properties of this test item were measured and listed in Table 1.

### Example 2c

The mixed solution from Example 2 was spun into a 70 denier spandex yarn with 5 filaments twisted together at a wind-up speed of 674 meters per minute. The as-spun yarn properties of this test item were measured and listed in Table 1.

### Example 2d

The mixed solution from Example 2 was spun into a 70 denier spandex yarn with 7 filaments twisted together at a wind-up speed of 716 meters per minute. The as-spun yarn properties of this test item were measured and listed in Table 1.

TABLE 1
As spun yarn tensile properties of Example 2

| Exam- | | TP2, | TM2, | TM2/ | DEC, | ELO, | TEN, |
|---|---|---|---|---|---|---|---|
| ple | Denier | g | g | TP2 | % | % | g |
| 1a | 40.7 | 5.72 | 1.140 | 0.199 | 31.1 | 439 | 42.0 |
| (compar- | | | | | | | |
| ative) | | | | | | | |
| 2a | 37.3 | 6.58 | 1.597 | 0.243 | 26.9 | 436 | 40.4 |
| 2b | 35.7 | 6.82 | 1.589 | 0.233 | 28.5 | 420 | 40.1 |
| 1b | 73.0 | 7.82 | 1.787 | 0.229 | 25.6 | 509 | 61.4 |
| (compar- | | | | | | | |
| ative) | | | | | | | |
| 2c | 65.7 | 8.89 | 2.379 | 0.268 | 24.1 | 499 | 52.6 |
| 2d | 69.0 | 9.26 | 2.590 | 0.280 | 24.8 | 477 | 64.1 |

As Table 1 indicated, the inventive fibers from Example 2 showed substantially higher recovery power (TM2) with increased TM2/TP2 ratios (or lower hysteresis) and without significant changes in yarn break elongation or tenacity.

### Example 3

PTG L-1400 glycol of 100.00 parts by weight was mixed and reacted with Isonate® 125MDR MDI of 28.52 parts, with the capping ratio (NCO/OH) at 1.61, to form an isocyanate-terminated prepolymer in a heated vessel with a percent of isocyanate groups (—NCO) at 2.80% of the prepolymer. This prepolymer was then dissolved in N,N-dimethylacetamide (DMAc) of 152.60 parts. This diluted prepolymer solution was allowed to react with a mixture of amines in DMAc solution, containing 2.51 parts of EDA, 0.02 parts of DETA, 0.23 parts of DEA and 85.32 parts of DMAc using a high speed disperser to form a homogenous polyurethaneurea solution with a polymer solids about 35.0% and a viscosity of 2500 poises measured at 40° C. This polymer solution was further mixed with a slurry of additives including 2.0% bleach resistant agent, 0.17% delusterant, 1.35% antioxidant, 0.3% spinning aid and 0.4% anti-tack additive based on the total solid weight.

### Example 3a

The polymer solution with additives, at a viscosity around 4000 poises measured at 40° C., from Example 3 was spun into a 40 denier spandex yarn with 4 filaments twisted together at a wind-up speed of 869 meters per minute.

### Example 3b

The polymer solution with additives, at a viscosity around 4000 poises measured at 40° C., from Example 3 was spun into a 40 denier spandex yarn with 5 filaments twisted together at a wind-up speed of 869 meters per minute.

### Example 4 (Comparative H350)

A commercially available 40 denier spandex fiber, claimed to be a spandex with high power and excellent heat resistance, which maintains its fabric power even setting at high temperature or re-dyeing.

### Example 5 (Comparative T582L)

A commercially available 40 denier spandex fiber, designed for improved heat resistance and fabric power retention under high temperature heat-setting and/or dyeing and re-dyeing process.

### Example 6 (Comparative T162B)

A commercially available 40 denier spandex fiber, used for general CK and WK fabric applications.

The as-spun yarn properties of inventive examples (Example 3) in comparison to the commercial comparative controls are given in Table 2.

TABLE 2
As-spun yarn tensile properties of Example 3 and comparison
properties of Commerical Comparative Controls

| Exam- | | TP2, | TM2, | TM2/ | DEC, | ELO, | TEN, |
|---|---|---|---|---|---|---|---|
| ple | DEN | g | g | TP2 | % | % | g |
| 3a | 40.7 | 6.84 | 1.576 | 0.230 | 23.0 | 479 | 39.8 |
| 3b | 41.7 | 7.95 | 1.679 | 0.211 | 23.8 | 462 | 38.8 |
| 4 | 42.0 | 6.75 | 1.204 | 0.178 | 29.6 | 477 | 44.7 |
| 5 | 42.0 | 6.41 | 1.103 | 0.172 | 28.2 | 489 | 43.0 |
| 6 | 39.3 | 6.50 | 1.105 | 0.170 | 28.9 | 479 | 47.7 |

As Table 2 indicated, the inventive fibers from Example 3 showed substantially higher recovery power (TM2) with increased TM2/TP2 ratios (or lower hysteresis) and without significant changes in yarn break elongation and with slight reduction in yarn break tenacity.

The yarn samples were further treated under conditions in simulation of fabric heat-setting process and high temperature dyeing process to assess their power retention and heat resistance.

The yarn heat-set test was carried out by stretching the yarn thread to 1.5×, heat-set with hot air at 190° C. for 120 seconds, followed by relaxed boil-off for 30 minutes. The heat-set efficiency (HSE %) for each thread samples was measured.

The yarn length growth test was carried out by stretching the yarn thread to 3.0×, heat-set with hot air at 190° C. for 120 seconds, followed by steam treatment under tension at 130° C. for 30 minutes. The percent of yarn thread length growth (LG %) was measured.

The HSE % and LG % data from inventive Example 3 together with comparative examples are given in Table 3a, which indicated that the inventive examples showed about the same dimensional changes under heat treatments as the best commercial comparative examples.

TABLE 3a
Yarn heat-set efficiency and length growth under heat treatment

| Example | HSE % | LG % |
|---|---|---|
| 3a | 69.6 | 151.1 |
| 3b | NA | 151.5 |
| 4 | 71.6 | 150.7 |
| 5 | 70.7 | NA |
| 6 | 78.0 | 163.4 |

The yarn properties after the heat-set test and length growth test were given in Table 3b and Table 3c respectively, which indicated that the inventive samples still retained substantially higher recovery power (TM2) and higher TM2/TP2 ratios (or lower hysteresis) relative to the comparative examples after the heat treatments.

TABLE 3b
Yarn tensile properties after heat-set treatment

| Exam- | | TP2, | TM2, | TM2/ | DEC, | ELO, | TEN, |
|---|---|---|---|---|---|---|---|
| ple | DEN | g | g | TP2 | % | % | g |
| 3a | 24.7 | 5.26 | 1.121 | 0.213 | 23.5 | 426 | 21.7 |
| 4 | 26.7 | 4.8 | 0.71 | 0.148 | 28.9 | 487 | 24.4 |
| 5 | 26.0 | 4.63 | 0.747 | 0.161 | 29.9 | 478 | 29.5 |
| 6 | 24.7 | 4.5 | 0.692 | 0.154 | 29.8 | 475 | 26.6 |

TABLE 3c
Yarn tensile properties after length growth test

| Exam- | | TP2, | TM2, | TM2/ | DEC, | ELO, | TEN, |
|---|---|---|---|---|---|---|---|
| ple | DEN | g | g | TP2 | % | % | g |
| 3a | 15.7 | 6.41 | 0.718 | 0.112 | 30.5 | 385 | 21.5 |
| 3b | 14.3 | 6.54 | 0.733 | 0.112 | 30.6 | 374 | 20.5 |
| 4 | 14.3 | 6.89 | 0.434 | 0.063 | 36.5 | 416 | 23.7 |
| 6 | 13.7 | 5.78 | 0.423 | 0.073 | 36.3 | 407 | 19.6 |

### Woven Fabric Examples:

The following examples demonstrate the present invention and its capability for use in manufacturing a variety of weight fabrics. The invention is capable of other and different embodiments, and its several details are capable of modifications in various apparent respects, without departing from the scope and spirit of the present invention. Accordingly, the examples are to be regarded as illustrative in nature and not as restrictive.

For each of the following six examples, 100% cotton staple spun yarn is used as warp yarn. They included two count yarns: 7.0 Ne OE yarn and 8.5 Ne OE yarn with irregular arrangement pattern. The yarns were indigo dyed in rope form before beaming. Then, they were sized and were made the weaving beam.

The inventive fiber of Example 2 and classic T162B LYCRA® fiber were used as elastic core and cotton fiber were used as sheath to make 16's cotton elastic core spun yarns. Such elastic core spun yarns were inserted into fabrics as weft yarn. Table 4 lists the materials and process conditions that were made and used to manufacture the core spun yarns for each example. Elastane fiber is available from Invista, s. á. r. L., of Wilmington, Del. and Wichita, Kans. For example, in the column headed Elastane fiber 78 dtex means 70 denier; and 3.8× means the draft of the elastic imposed by the core spinning machine (machine draft). In the column headed ‘Hard Yarn’, 16's is the linear density of the spun yarn as measured by the English Cotton Count System. The rest of the items in Table 4 are clearly labeled.

Stretch woven fabrics were subsequently made, using the core spun yarn of each example in Table 4 as weft. Table 5 summarizes the yarns used in the fabrics, the weave pattern, and the quality characteristics of the fabrics. Some additional comments for each of the examples are given below. Unless otherwise noted, the fabrics were woven on a Donier air-jet loom. Loom speed was 500 picks/minute. The widths of the fabric were about 76 and about 72 inches in the loom and greige state respectively.

Each greige fabric in the examples was finished by: scouring, desizing, relaxation and adding softener.

TABLE 4
Weft Yarn Specification

| | Elastane | | Elastane | | | | |
|---|---|---|---|---|---|---|---|
| | Fiber | Elastane | Fiber | LYCRA ® | LYCRA ® | | |
| Exam- | Dtex | Fiber | Spinning | fiber | fiber | Hard | Yarn twist |
| ple | (Denier) | Filaments | speed | Type | Draft | Yarn | per inch |
| 7 | 78 dtex | 5 | Normal | T162C | 3.8X | 16′S | 16 turns |
| | (70 D) | | | | | cotton | |
| 8 | 78 dtex | 5 | Normal | Ex. 2 | 3.8X | 16′S | 16 turns |
| | (70 D) | | | | | cotton | |
| 9 | 78 dtex | 7 | High | Ex. 2 | 3.8X | 16′S | 16 turns |
| | (70 D) | | | | | cotton | |
| 10 | 78 dtex | 5 | Normal | T162C | 4.1X | 16′S | 16 turns |
| | (70 D) | | | | | cotton | |
| 11 | 78 dtex | 5 | Normal | Ex. 2 | 4.1X | 16′S | 16 turns |
| | (70 D) | | | | | cotton | |
| 12 | 78 dtex | 7 | High | Ex. 2 | 4.1X | 16′S | 16 turns |
| | (70 D) | | | | | cotton | |

TABLE 5
Fabric Example List

| | | | | | | | | | | Fabric | | Fabic |
|---|---|---|---|---|---|---|---|---|---|---|---|---|
| | | | | | | | | | Width | Shrinkage | | recovery |
| | | | | Fabric on | | | | | (in) | after 3 | Normal- | power |
| | | | | loom | Fabric | Fabric | Fabric | Fabric | after 3 | times wash | ized | @12% |
| Exam- | | Warp | Weave | (warp EPI × | Weight | Stretch | Growth | Recovery | times | % | Hyster- | extension |
| ple | Weft Yarn | Yarn | pattern | weft (PPI) | OZ/Y\hat{ }2 | % | % | % | wash | (W × F) | esis | g |
| 7 | 16′ cotton/ | 7.75s | ⅓ | 76 × 54 | 11.6 | 42.7 | 7.2 | 78.92 | 47 | −5.60 × −7.55 | 13.5 | 395.6 |
| | 70 D T162C | 100% | twill | | | | | | | | | |
| | 3.8X CSY | cotton OE | | | | | | | | | | |
| | | Indigo | | | | | | | | | | |
| 8 | 16′ cotton/ | 7.75s | ⅓ | 76 × 54 | 11.7 | 41.3 | 6.1 | 81.54 | 47 | −5.73 × −7.42 | 13.0 | 455.7 |
| | Ex. 2c- | 100% | twill | | | | | | | | | |
| | 3.8X CSY | cotton OE | | | | | | | | | | |
| | | Indigo | | | | | | | | | | |
| 9 | 16′ cotton/ | 7.75s | ⅓ | 76 × 54 | 12.0 | 44.5 | 5.5 | 84.55 | 46 | −5.21 × −7.68 | 11.0 | 508.5 |
| | Ex. 2d- | 100% | twill | | | | | | | | | |
| | 3.8X CSY | cotton OE | | | | | | | | | | |
| | | Indigo | | | | | | | | | | |
| 10 | 16′ cotton/ | 7.75s | ⅓ | 76 × 54 | 11.8 | 42 | 8.8 | 73.81 | 47 | −5.73 × −8.20 | 13.7 | 419.4 |
| | 70 D T162C | 100% | twill | | | | | | | | | |
| | 4.1X CSY | cotton OE | | | | | | | | | | |
| | | Indigo | | | | | | | | | | |
| 11 | 16′ cotton/ | 7.75s | ⅓ | 76 × 54 | 11.7 | 42 | 7.4 | 77.08 | 47 | −5.73 × −7.68 | 12.8 | 454.1 |
| | Ex. 2c - | 100% | twill | | | | | | | | | |
| | 3.8X CSY | cotton OE | | | | | | | | | | |
| | | Indigo | | | | | | | | | | |
| 12 | 16′ cotton/ | 7.75s | ⅓ | 76 × 54 | 11.9 | 45.9 | 7 | 80.94 | 45.5 | −5.47 × −7.68 | 10.8 | 506.2 |
| | Ex. 2d- | 100% | twill | | | | | | | | | |
| | 4.1X CSY | cotton OE | | | | | | | | | | |
| | | Indigo | | | | | | | | | | |

### Example 7: Stretch Denim with Normal Elastic Core-Spun Yarn (CSY)

This is a comparison example, not according to the invention. The warp yarn was 7.0 Ne count and 8.4 Ne count mixed open end yarn. The warp yarn was indigo dyed before beaming. The weft yarn is 16Ne core spun yarn with 70D/5fTI62C Lycra® spandex. The Lycra® fiber was drafted 3.8× during covering process. Table 5 lists the fabric properties. This fabric had weight (11.6 g/m²), stretch (42.7%), growth (7.2%), recovery (78.9%) and recovery power under 12% extension (395.6 grams).

### Example 8: Stretch Denim Containing Inventive Elastic CSY

This sample had the same fabric structure as example 7. The difference was the core spun yarn in weft direction, which containing 70D/5finventive fiber of 2c spun under normal speed. This fabric used the same warp and structure as Example 7. Also, the weaving and finishing process were the same as Example 7. Table 5 summarizes the test results. We can see that this sample had low fabric growth (6.1%), high recovery (81.5%) and high recovery power (455.7 grams) than fabrics in example 7.

### Example 9: Stretch Denim with Inventive Elastic CSY Spun Under High Speed

This sample had the same fabric structure as in Example 7 and Example 8. The only difference was the use of 70D/7f inventive fiber of Example 2d. This new fiber is spun under high speed. Table 5 summarizes the test results. It is clearly shows that this sample has higher stretch (44.5%), lower fabric growth level (5.5%), higher recovery (84.56%), low hysteresis (11.0%) and narrow fabric width (46 inch) and heavier weight (11.99 Oz/ŷ2). All these data show that inventive elastic fiber has higher recovery force and power than normal spandex fiber. By using this new fiber, the fabric has high stretch, high recovery and excellent shape retention.

### Example 10: Stretch Denim with Normal Elastic CSY

This is a comparison example, not according to the invention. The warp yarn was 7.0 Ne count and 8.4 Ne count mixed open end yarn. The warp yarn was indigo dyed before beaming. The weft yarn is 16 s cotton core spun yarn with 70D/5fT162C Lycra® spandex. The Lycra® fiber was drafted 4.1× during covering process. Table 5 lists the fabric properties. This fabric had weight (11.8 g/m²), stretch (42.0%), growth (8.8%), recovery (73.8%) and recovery power under 12% extension (419.4 grams).

### Example 11: Stretch Denim Containing Inventive CSY

This sample had the exactly same fabric structure as example 10. The difference was the core spun yarn in weft direction, which containing 70D/5finventive fiber of Example 2c spun under normal speed. The inventive fiber was drafted 4.1× during covering process. This fabric used the same warp and structure as Example 10. Also, the weaving and finishing process were the same as Example 10. Table 5 summarizes the test results. We can see that this sample had low fabric growth (7.7%), high recovery (77.98%) and high recovery power (454.1 grams) than fabrics in example 10.

### Example 12: Stretch Denim with Inventive Elastic CSY Spun Under High Speed

This sample had the same fabric structure as in Example 10 and Example 11. The only difference was the use of 70D/7f inventive fiber of Example 2d new elastic fiber under 4.1× draft. This new fiber is spun under high speed. Table 5 summarizes the test results. It is clearly shows that this sample has higher stretch (45.9%), lower fabric growth level (7.0%), higher recovery (80.93%), low hysteresis (10.8%) and narrow fabric width (45.5 inch) and heavier weight (11.87 Oz/ŷ2). All these data indicate again that inventive elastic fiber has higher recovery force and power than normal spandex fiber. By using this new fiber, the fabric has high stretch, high recovery and excellent shape retention.

### Knit Fabric Examples

The following examples demonstrate the present invention and its capability for use in knit fabrics. The invention is capable of other and different embodiments, and its details are capable of modifications in various apparent respects, without departing from the scope and spirit of the present invention. Accordingly, the examples are to be regarded as illustrative in nature and not as restrictive.

Three examples of stretch knit fabrics were made. Table 6 summarizes the yarns used in the fabrics, the fabric construction, the elastane fiber draft and physical quality characteristics of the finished fabrics. For example, in the column headed elastane fiber draft, 2.6× means the extension imposed on the elastane fiber in the knitting process. For the 3 rightmost columns, the hot wet ageing process required submerging fabric samples in water at 130 degrees Celsius and a pH of 5.0 for the amount of time noted in the column heading. Also in these columns, residual % is the amount of recovery power relative to the recovery power of the fabric prior to hot wet ageing expressed as a percentage. The remaining items are clearly labeled. The fabrics were knit on a Monarch single jersey circular knitting machine with 28 cut, 26 inch diameter and at 18 revolutions per minute. For each of the examples, a nylon yarn is used as the companion hard yarn in the fabric. Specifically, this nylon yarn is a type 6,6 fully drawn yarn available from INVISTA Sari, of Wilmington, Del., with the type designation 40/13-T6300. The inventive elastic fibers of examples 2a, 2b, and standard T162B LYCRA® fiber, also available from INVISTA Sarl, of Wilmington, Del., were used as plaiting yarns in the knitting of the examples.

Each greige fabric in the examples was finished by applying anti-oxidant, heat setting at 193 degrees Celsius for 45 seconds, aqueous dyeing at 98 degrees Celsius for 40 minutes, and drying at 140 degrees Celsius for 45 seconds.

TABLE 6

| | | | | | | | Fabric |
|---|---|---|---|---|---|---|---|
| | Elastane | | | Elastane | Fabric | Fabric | Total |
| | Fiber | Companion | | Fiber | Weight | Width | Elongation |
| Example | Type | Hard Yarn | Construction | Draft | grams/sqm | inches | % |
| 13 | 44 dtex | 44 dtex | 28 Cut | 2.6X | 93.6 | 51 | 195 |
| | (40 Denier) | (40 denier) | Circular Knit | | | | |
| | 3 Filament | 13 Filament | Single Jersey | | | | |
| | T162B | FDY Nylon 6,6 | | | | | |
| | | 40/13-T6300 | | | | | |
| 14 | 44 dtex | 44 dtex | 28 Cut | 2.6X | 88.8 | 50 | 192 |
| | (40 denier) | (40 denier) | Circular Knit | | | | |
| | 4 Filament | 13 Filament | Single jersey | | | | |
| | EX, 2b | FDY Nylon 6,6 | | | | | |
| | fiber | 40/13-T6300 | | | | | |
| 15 | 45 dtex | 44 dtex | 28 Cut | 2.6X | 91.2 | 50 | 192 |
| | (40 denier) | (40 denier) | Circular Knit | | | | |
| | 4 Filament | 13 Filament | Single jersey | | | | |
| | Ex. 2a | FDY Nylon 6,6 | | | | | |
| | fiber | 40/13-T6300 | | | | | |

| | | Fabric Recovery | Fabric Recovery | Fabric Recovery |
|---|---|---|---|---|
| | | Power @40% | Power @40% | Power @40% |
| | | Unload Extension | Unload Extension | Unload Extension |
| | Fabric Recovery | After 30 Min | After 60 Min | After 90 Min |
| | Power @40% | Hot Wet Ageing | Hot Wet Ageing | Hot Wet Ageing |
| | Unload Extension | Grams Force | Grams Force | Grams Force |
| Example | Grams Force | (Residual %) | (Residual %) | (Residual %) |
| 13 | 261.5 | 205.3 | 192 | 161.1 |
| | | (78.5%) | (73.4%) | (61.6%) |
| 14 | 228.1 | 199.5 | 195.6 | 192.8 |
| | | (87.5%) | (85.8%) | (84.5%) |
| 15 | 241.4 | 207.1 | 203.1 | 183.1 |
| | | (85.8%) | (84.1%) | (75.8%) |

### Example 13: Stretch Knit Fabric with Standard Elastane

J This is a comparison example, not according to the invention. The elastane was 40 denier T162B LYCRA® elastane. The elastane fiber was drafted 2.6× in the knitting process. The companion hard fiber was 40/13-T6300. Table 6 lists the fabric properties. This fabric had weight (93.6 g/m2), width (51 in), elongation (195%), recovery power (261.5 gF) and residual recovery power after hot wet ageing for 30, 60 and 90 minutes (78.5%, 73.4%, 61.6% respectively).

### Example 14: Stretch Knit Fabric with Inventive Elastane Spun at High Speed

This example had the same fabric structure as example 13. The only difference was the use of the inventive fiber of Example 2b fiber spun at high speed in place of the 40 denier T162B LYCRA® elastane. Table 6 lists the fabric properties. This fabric had weight (88.8 g/m2), width (50 in), elongation (192%), recovery power (228.1 gF) and residual recovery power after hot wet ageing for 30, 60 and 90 minutes (87.5%, 85.8%, 84.5% respectively). These data show that inventive elastic fiber has higher residual power after hot wet aging than standard elastane.

### Example 15: Stretch Knit Fabric with Inventive Elastane Spun at Low Speed

This example had the same fabric structure as example 13. The only difference was the use of the inventive fiber of Example 2a fiber spun at low speed in place of the 40 denier T162B LYCRA® elastane. Table 6 lists the fabric properties. This fabric had weight (91.2 g/m2), width (50 in), elongation (192%), recovery power (241.4 gF) and residual recovery power after hot wet ageing for 30, 60 and 90 minutes (85.8%, 84.1%, 75.8% respectively). These data show that inventive elastic fiber has higher residual power after hot wet ageing than standard elastane.

Higher Power Fiber Benefits for Hygiene Applications:

A review of the stress/strain curves (not shown) of LYCRA® fiber T837 680 dtx and a 688 dtx fiber of the composition in Inventive Example 3 demonstrates that the force for the inventive fiber is significantly higher than T837 through most of the retractive side of the cycle. The higher retractive force corresponds to a greater ability for the fiber to overcome the blocking action of hot melt elastic attachment adhesives and nonwovens used to construct the leg, cuff, waistband or other stretch components of a diaper or hygiene article. The more robust retraction of the diaper leg and/or cuff would correspond to greater gasketing action against the body of the wearer and lower probability of leaks. The inventive fiber provides an opportunity to redistribute retractive forces within the hygiene article to improve comfort and fit.

### Replacing LYCRA@ Fiber T837 with the Lighter Denier Inventive

Supply packages of spandex provide run times related to the length of fiber on the roll for hygiene article manufacturers using rolling-take-off unwind equipment. For the same mass supply package, a lighter denier will provide more length than a heavier denier. The run time will be longer for the lighter denier package than the heavier denier package so fewer product line stops will be needed over a given production period. Less downtime corresponds to higher productivity. For over-end-take-off unwind equipment the lighter package with greater length corresponds to fewer transfers over a given production period that reduces the chance for a failed transfer and corresponding downtime for repairing the failure.

Using a lighter denier inventive spandex also reduces the mass of spandex consumed in the diaper. Although the mass saved per unit is fractions of grams, the overall mass saved in the industry is potentially several kTons.

Another benefit of using higher power inventive spandex is the opportunity to maintain or increase denier of the threadline to potentially reduce the overall number of threadlines used in the diaper component. The higher retractive force fiber with the same or denier may be used to reduce the number of threadlines while maintaining the desired retractive forces. A benefit of this scenario is to reduce the adhesive consumed in relation to the threadline reduction. Managing fewer threadlines also simplifies the hygiene article production process with less material handling and a reduction in corresponding threadline guides and adhesive application components.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

1. An elastic fiber comprising a polyurethaneurea that is the reaction product of:
(a) a prepolymer comprising the reaction product of
(i) a polyol comprising a copolymer of tetrahydrofuran and 3-methyltetrahydrofuran having a number average molecular weight of 1000 to 2000 and
(ii) a diisocyanate; and
(b) a chain extender.

2. The elastic fiber of claim 1, wherein the copolymer of tetrahydrofuran and 3-methyltetrahydrofuran has a number average molecular weight of 1200 to 1800.

3. The elastic fiber of claim 1, wherein the prepolymer has % NCO of 2.6 to 3.6.

4. The elastic fiber of claim 1, wherein the prepolymer has % NCO of 2.8 to 3.6.

5. The elastic fiber of claim 1, wherein the prepolymer has % NCO of 2.8 to 3.2.

6. The elastic fiber of claim 1, wherein the chain extender is a diamine chain extender.

7. The elastic fiber of claim 1, wherein the chain extender consists only of a linear diamine chain extender.

8. The elastic fiber of claim 1, wherein the chain extender consists only of ethylene diamine.

9. The elastic fiber of claim 1, wherein the polyol comprises only the copolymer of tetrahydrofuran and 3-methyltetrahydrofuran or a combination of the copolymer and a different polyol.

10. The elastic fiber of claim 9, wherein the different polyol a single additional polyol or a blend of polyols selected from the group consisting of polycarbonate glycols, polyester glycols, polyether glycols and combinations thereof.

11. The elastic fiber of claim 1, wherein the polyol comprises about 50% to about 100% of the copolymer of tetrahydrofuran and 3-methyltetrahydrofuran.

12. The elastic fiber of claim 1, wherein the copolymer of tetrahydrofuran and 3-methyltetrahydrofuran includes about 5 to about 75 mole % of 3-methyltetrahydrofuran.

13. A fabric comprising an elastic fiber comprising a polyurethaneurea that is the reaction product of:
(a) a prepolymer comprising the reaction product of
(i) a polyol comprising a copolymer of tetrahydrofuran and 3-methyltetrahydrofuran having a number average molecular weight of 1000 to 2000 and
(ii) a diisocyanate; and
(b) a chain extender.

14. The fabric of claim 13, wherein the fabric retains power after heat treatment.

15. The fabric of claim 13, wherein the fabric comprises a knit or woven construction.

16. A hygiene article comprising a polyurethaneurea that is the reaction product of:
(a) a prepolymer comprising the reaction product of
(i) a polyol comprising a copolymer of tetrahydrofuran and 3-methyltetrahydrofuran having a number average molecular weight of 1000 to 2000 and
(ii) a diisocyanate; and
(b) a chain extender.
